(19) United States
(12) Patent Application Publication
(10) Pub. No.: US 2015/0239446 A1
(43) Pub. Date: Aug. 27, 2015

(54) CABLE SYSTEM FOR A VEHICLE PARKING BRAKE

(71) Applicant: Ford Global Technologies, LLC, Dearborn, MI (US)

(72) Inventor: Brian Phillips, Royal Oak, MI (US)

(73) Assignee: Ford Global Technologies, LLC, Dearborn, MI (US)

(21) Appl. No.: 14/191,597

(22) Filed: Feb. 27, 2014

(51) Int. Cl. B60T 11/04; B60T 7/10

(52) U.S. Cl. CPC B60T 11/046; B60T 7/102

(57) ABSTRACT

A parking brake assembly for use with a motor vehicle including first and second brake assemblies having a common cable. The assembly including a conduit disposed over the cable wherein one end of the conduit connects to a movable member or brake lever of one of the first and second brake assemblies. The opposite end of the conduit connects to a fixed member on the remaining brake assembly. The brake lever connected to the conduit functions as a conduit reaction bracket.

### CROSS-REFERENCE TO RELATED APPLICATIONS

Not Applicable

### BACKGROUND OF THE INVENTION

1. Field of the Invention

The present invention relates generally to a vehicle parking brake and, more particularly, to a parking brake system including a conduit reaction park brake cable.

2. Description of Related Art

Vehicle parking brakes may include a cable system having cable and a conduit. While conduit surrounds and guides the cable, it also functions as a force member. Such systems are often referred to as conduit-reaction-type systems and often require multiple cables/conduits and reaction brackets to connect a brake actuation member such as a parking brake pedal or handle to the braking mechanism associated with the rear wheels of a vehicle.

Such systems typically operate such that tension on the cable operates a brake on the first wheel with the tension straightening the reaction conduit and displacing the reaction bracket causing a second strand to operate the opposite rear wheel brake operating means. Such systems often require multiple reaction brackets or arrangements for equalizing the force between the cables or conduit extending between the respective rear wheels of the vehicle. Such systems often have durability issues due to the large amount of unsupported conduit needed to account for relative motion between the vehicle axle and frame.

### SUMMARY OF THE INVENTION

In one embodiment of the present invention the parking brake system uses one of the rear brake levers on one of the rear brakes as a reaction bracket. In one example, the parking brake system includes a first brake assembly having a movable member and a second brake assembly having a movable member. A cable connects a movable member of either the first brake assembly or second brake assembly with a brake actuation member. A conduit attaches to the movable member of the remaining brake assembly. In the disclosed example, the cable attaches to the movable member of the second brake assembly and the conduit attaches to the movable member of the first brake assembly.

The present invention further contemplates a method for actuating a vehicle brake wherein a continuous cable extends from a brake actuation member past the first brake assembly and connects to the second brake assembly. A conduit extends from the second brake assembly and connects to the first brake assembly whereby the conduit cooperates with a movable member on the first brake assembly such that a movable member functions as a conduit reaction bracket.

Further areas of applicability of the present invention will become apparent from the detailed description provided. It should be understood that the detailed description and specific examples, while indicating the preferred embodiment of the invention, are intended for illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic plan view of one example of a cable system for a vehicle parking brake according to the present invention.

FIG. 2 is a partial top view of the first brake assembly associated with one of the vehicle rear wheels, the left wheel.

FIG. 3 is a partial top view of the second brake assembly associated with one of the vehicle rear wheels, the right wheel.

### DETAILED DESCRIPTION OF THE PREFERRED EMBODIMENTS

The following description of the preferred embodiment(s) is merely exemplary in nature and is not intended to limit the invention, its application, or uses.

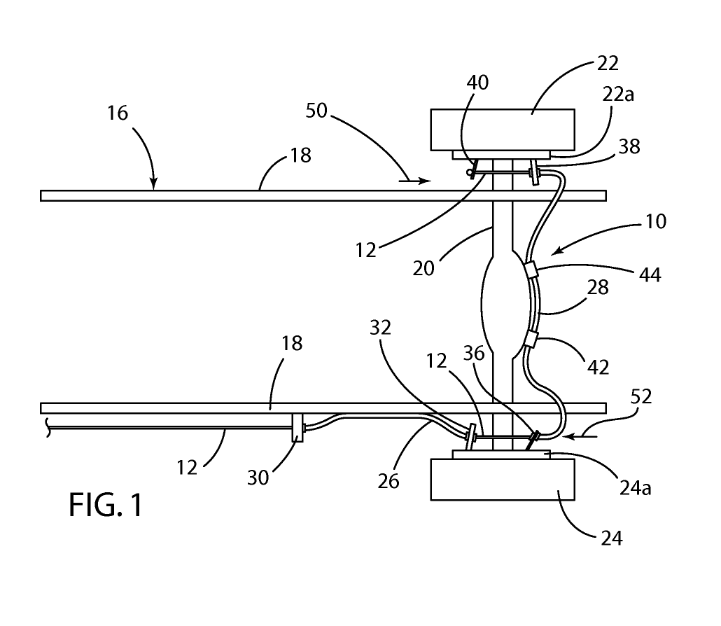

FIG. 1 illustrates an example of a cable system, seen generally at 10, including brake lever used as a conduit reaction bracket. The cable system 10 shown is used with a parking brake of a motor vehicle. The cable system 10 includes a cable or cable strand 12 connected on one end to a brake actuator or actuation member, typically a brake handle or pedal (not shown), located in the vehicle operator compartment of a vehicle 16. The vehicle includes longitudinally extending frame members 18 supporting a rear axle 20. The axle 20 rotatably supports right and left wheels 22, 24. The terms right and left are for illustration, with the term “left” associated with the wheel 24 on the left side of the vehicle as the vehicle 16 is traveling forward. Each of the right and left wheels 22, 24 include a brake assembly 22a, 24a that when engaged prevents rotation of the wheel. The vehicle operator uses the brake actuation member to apply tension to the cable 12 and engage the brake assemblies 22a, 24a associated with each wheel 22, 24. Releasing the tension on the cable 12 releases the brake assemblies 22a, 24a and the wheels 22, 24 may rotate.

Turning now to the present example of the cable system 10, a single or continuous piece of cable strand 12 connects to the parking brake (not shown). The cable system further includes first and second sections of cable conduit 26, 28. The cable 12 extends through a conduit abutment plate 30 connected to the frame 18 and through a fixed abutment member 32 associated with the brake assembly 24a of the left wheel 24. The conduit abutment plate 30 and fixed abutment member 32 rigidly attach to the vehicle and their respective connection points do not move. As illustrated, the first section of conduit 26 extends between the conduit abutment plate 30 and fixed abutment member 32. The conduit 26 need only have a length suitable to compensate for the jounce/rebound of the wheel 24 in relation to the frame 18.

The cable 12 continues from the fixed abutment plate 32 and extends through a brake lever 36 associated with the brake assembly 24a of the left wheel 24, the second section of conduit 28, a second abutment member 38 and attaches to a second brake lever 40. In the disclosed example, the cable 12 is one continuous piece of cable strand extending from the brake actuation member to the brake lever 40 of the brake assembly 22a associated with the right wheel 22. The cable 12 located within two separate sections of conduit 26, 28. First and second conduit guides 42, 44 attached to the rear axle 20 support the second section of conduit 28.

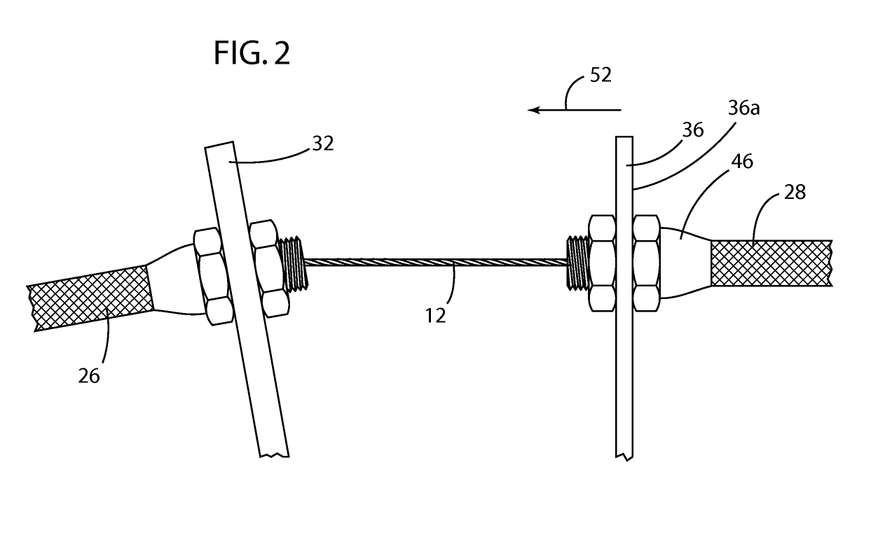

As illustrated in FIG. 2, a conduit end fitting 46 attaches one end of the second section of conduit 28 to the brake lever 36 of the brake assembly 24a. The cable 12 is not directly attached or connected to and passes through the brake lever 36. That is the rear or backside 36a of the brake lever 36 is modified to accept the second section of conduit 28 and operates as a moving abutment member. The brake lever 36 acts as a conduit reaction bracket.

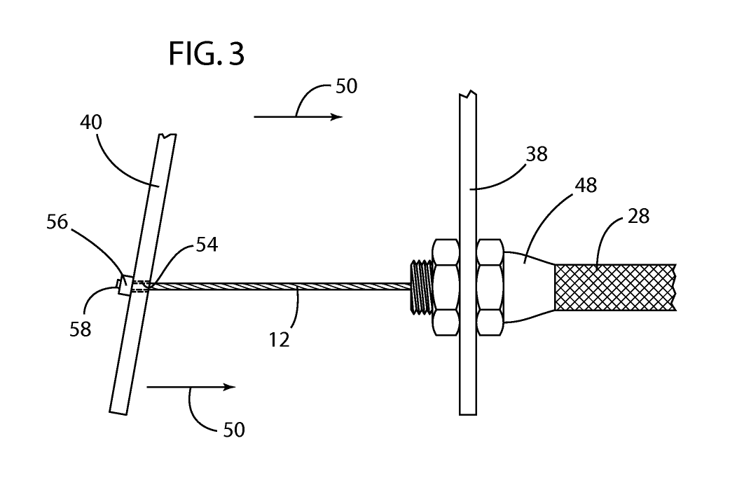

As illustrated in FIG. 3, a conduit end fitting 48 connects the opposite end of the second section of conduit 28 to the abutment member 38 of the brake assembly 24a. In the present example, the cable 12 extends through an aperture 54 in the second brake lever 40 and has a cable end fitting 56 swaged on the end 58 of the cable 12. Tension in the cable 12 operates to pull the brake lever 40 of the brake assembly 22a and correspondingly actuate the brake assembly 22a associated with the right wheel 22. The second section of conduit 28 functions as the reaction loop and is only required to have enough length for the reaction loop.

In operation, actuation of the brake actuation member pulls on and correspondingly generates tension in the cable 12. Since the cable 12 passes through the brake lever 36 of brake assembly 24a and travels through second section of conduit 28 tension in the cable 12 pulls the brake lever 40 of the brake assembly 22a rearwardly in the direction shown by the arrow 50 to actuate or engage the brake assembly 22a associated with the right wheel 22. When the cable 12 pulls the brake lever 40 the cable 12 acts on the second section of conduit 28 such that the second section of conduit 28 pushes the brake lever 36 of the brake assembly 24a forward in the direction shown by the arrow 52 to actuate or engage the brake assembly 24a associated with the left wheel 24. The cable 12 is one continuous piece of strand with two sections of conduit 26, 28. This reduces the number of parts and the potential failure points.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A parking brake system comprising:
a cable;
a movable member connected to a first brake assembly;
a movable member connected to a second brake assembly, said cable connected to one of said first and said second movable members; and
a conduit, said conduit connected to one of said movable members.

2. A system as set forth in claim 1 including said conduit attached to said movable member of said first brake assembly and said cable attached to said movable member of said second brake assembly.

3. A system as set forth in claim 2 wherein said members are brake levers.

4. A system as set forth in claim 1 wherein said conduit is connected on one end to one of said movable members and on an opposite end to a fixed member.

5. A system as set forth in claim 2 wherein said cable extends through said conduit and attaches to said movable member.

6. A system as set forth in claim 1 when said cable includes a single strand extending past said movable member of said first brake assembly and attached to said movable member of said second brake assembly.

7. A system as set forth in claim 1 including a first section of conduit, said first section extending between an abutment plate attached to a frame member and a fixed member of said first brake assembly; and
a second section of conduit, said second section extending between one of said movable member of said first brake assembly and a fixed member of said second brake assembly.

8. A system as set forth in claim 7 wherein said fixed member of said first brake assembly is located adjacent a first wheel and said fixed member of said second brake assembly is located adjacent a second wheel.

9. A system as set forth in claim 1 including;
said cable being a continuous strand extending past said movable member of said first brake assembly and attached to said movable member of said second brake assembly;
a first section of conduit, said first section extending between an abutment plate attached to a frame member and a fixed member adjacent said first brake assembly; and
a second section of conduit, said second section extending between said movable member of said first brake assembly and a fixed member adjacent said second brake assembly wherein said strand extends through said second section of conduit.

10. A vehicle brake comprising:
a first brake assembly, said first brake assembly including a brake lever and a fixed member;
a second brake assembly, said second brake assembly including a brake lever and a fixed member;
a brake actuation member;
a continuous cable starting at said brake actuator, extending through said first brake assembly and ending at said second brake assembly.

11. A vehicle brake as set forth in claim 10 including a conduit, said conduit disposed over said continuous cable and extending between said first brake assembly and said second brake assembly.

12. A vehicle brake as set forth in claim 11 wherein said conduit connects on one end to said brake lever of said first brake assembly and on an opposite end to said fixed member of said second brake assembly.

13. A vehicle brake as set forth in claim 10 wherein said continuous cable extends past the brake lever of said first brake assembly and is attached to said brake lever of the second brake assembly;
a conduit, said conduit disposed over said continuous cable between said first brake assembly and said second brake assembly; and
a connector connecting said conduit to said brake lever of said first brake assembly.

14. A vehicle brake as set forth in claim 13 wherein said continuous cable extends freely through an opening in said brake lever of said first brake assembly.

15. A vehicle brake as set forth in claim 10 wherein said continuous cable is connected to said brake lever of said second brake assembly and extends freely through an opening in said brake lever of said first brake assembly.

16. A vehicle brake as set forth in claim 15 including a conduit, said conduit disposed over said continuous cable and extending between said brake lever of said first brake assembly and a fixed member of said second brake assembly.

17. A vehicle brake assembly as set forth in claim 16 including a conduit connector connecting said conduit to said brake lever of said first brake assembly; and
a conduit connector connecting said conduit to said fixed member of said second brake assembly.

18. A method for actuating a vehicle brake comprising the steps of:
providing a first brake assembly, said first brake assembly including a brake lever and a fixed member, a second brake assembly, said second brake assembly including a brake lever and a fixed member, a brake actuation member and a continuous cable starting at said brake actuation member, extending through said first brake assembly and ending at said second brake assembly;
using said brake actuation member to apply a tensile force to the continuous cable whereby the tensile force on said continuous cable causes movement of said brake lever of said first brake assembly to actuate the first brake assembly and causes movement of said brake lever of said second brake assembly to actuate the second brake assembly.

19. A method as set forth in claim 18 including the step of providing a conduit, said conduit disposed over said continuous cable wherein a tensile force in the cable causes the conduit to apply a force to a brake lever of one of first brake assembly and the second brake assembly and actuate the first brake assembly and the second brake assembly.

20. A method as set forth in claim 18 wherein the brake lever of the first brake assembly functions as a conduit reaction bracket.
